(19) United States
(12) Patent Application Publication
(10) Pub. No.: US 2022/0036262 A1
(43) Pub. Date: Feb. 3, 2022

(54) Method and System for Normalization and Aggregation of Risks

(71) Applicant: INBARIO AS, Vikhammer (NO)

(72) Inventor: Harald Amundsen, Jakobsli (NO)

(21) Appl. No.: 17/312,611

(22) PCT Filed: Jan. 30, 2020
(86) PCT No.: PCT/NO2020/050019

§ 371 Date: Jun. 10, 2021

(30) Foreign Application Priority Data
Jan. 30, 2019 (NO) 20190116

(51) Int. Cl. G06Q 10/06; G06N 20/00

(52) U.S. Cl. CPC G06Q 10/0635; G06N 20/00; G06Q 10/06375

(57) ABSTRACT

Method and system for normalization of risks using mapping of risk matrices, wherein the consequence and probability rating scales are normalized to the same range, and wherein the risks are normalized to wards an extended risk matrix mapping area. The method and system will further be arranged for normalized presentation and aggregation of risks in protection layer hierarchies, wherein the risks are presented as if they had been assessed in other protection layers, for example in other organizational layers.

### BACKGROUND

The disclosed embodiments relate to a method for normalization and aggregation of risks and to a system for normalization and aggregation of risks.

A risk is a random event that may possibly occur and, if it did occur, would have a negative impact on the goals of the organization. Thus, a risk is composed of three elements: the scenario; its probability of occurrence; and the size of its impact if it did occur (either a fixed value or distribution).

An opportunity is also a random event that may possibly occur but, if it did occur, would have a positive impact on the goals of the organization. Thus, an opportunity is composed of the same three elements as a risk.

Risk exists in every business activity, and risk management has become an integral part of modern business management.

Risk management solutions, such as Enterprise Risk Management (ERM) systems, are used for managing risk. These systems typically use the terms ‘risk’ if the potential outcome is a negative and ‘opportunity’ if the potential outcome is positive.

Risk matrices are used during risk assessment to define the levels of risk because neither the probability (likelihood) nor consequences (severity/impact) can typically be estimated with accuracy and precision. Using a risk matrix therefore typically involves an assessment of two input dimensions, i.e. the consequence and the probability. Both dimensions (axes) in the matrix are normally categorized into a limited number of categories. Most matrices have between three and seven categories on each axis. The categories may be either semi-quantitative or quantitative, for example low/medium/high or 0-2/3-7/8-10.

Risk normalization ensures that risks are reported in the organization as if they were assessed by the risk matrices used by the superior organization layer and not with the matrix used when the risk was originally assessed. This ensures that relevant risks are reported as if they were created in the superior organizational levels, i.e. even if the superior organizational levels are using other risk matrices when assessing risks, In addition, normalization of risks ensures that irrelevant risks are not reported making it easier for the organization to focus on the most critical risk issues.

US 20090070170 A1 discloses a risk assessment method where risk matrix ranges and the risks are scaled such that the values are represented in percentages (0-100%).

US 20170093863 A1 describes a method for combining a set of risk factors to calculate a total risk score within a risk engine.

U.S. Pat. No. 6,895,383 B2 teaches a computer-implemented method and system for calculating the modified overall risk.

WO 2018026286 A1 describes organizing risks into protection layer hierarchies and visualization of these layers in structural line relationship diagrams typically resembling the structure of an organization and the relationships relative ranks of its parts and positions.

US WO2015137970 A1 describes creation and presentation of standard and unique risk matrices with different risk levels based on the results from advanced analytic and statistics.

U.S. Pat. No. 10,504,028 B1 teaches techniques to use machine learning for risk management.

The main drawback of prior art is that it does not teach a solution where normalized risk assessments are aggregated and presented in protection layer hierarchies ensuring automated reporting of relevant risks compared to time-consuming manual reporting of risks in the organization.

A technical effect of this automated risk reporting between organizational layers is that risk assessments are done automatically, thus significantly faster compared to the manual reporting required by prior art where the risks must be re-created or re-assessed manually resulting in delayed risk reporting and risk awareness in superior organizational layers. With prior art, an important risk must typically be re-assessed in several organizational layers before it finally reaches the top management organizational layer.

A further drawback of the mentioned prior art is that they are not able to provide a solution for risk normalization between the risk matrices used by the ERM system.

Another drawback of prior art is that they do enable the users to adjust the normalization rules from the graphical user interface without adjusting any mathematical parameters and/or functions.

Yet another drawback of prior art is that they do teach risk mapping methods that can be used by a machine learning function for precise risk normalizations based on the mapping of risk matrices. In addition, these mappings are easily understandable by an expert, or even an ordinary user, as these mapping relationships can be presented in the ERM graphical user interface, thereby making it easy to see and understand the basis on the machine learning function.

Although machine learning models are widely used in many applications, they often fail to explain their decisions and actions to users. Without a clear understanding it is hard for users to incorporate their knowledge into the learning process, resulting in a time-consuming trial-and-error process.

Therefore, there is also a need for the disclosed embodiments related to machine learning as it visualizes the risk normalization methods used by the model in an understandable and useful format to users of the ERM system.

### SUMMARY

Provided herein is a method and system for normalization of risk assessments partly or entirely solving the drawbacks of prior art.

The disclosed embodiments allow presentation of normalized risks in aggregated protection layer hierarchies where the risks are presented as if they had been assessed by the risk matrices used in other protection layers, for example in other layers in an organization, such as a parent layer.

Also provided is a method and system for easily configuration of the risk normalization rules, i.e. the relationship between the different risk matrices without the need to adjust adjusting any mathematical parameters and/or functions.

Also provided is a method and system for automatic normalization of risk assessments using machine learning functions.

In today's competitive global economy, companies are faced with many difficult decisions that require immediate attention. Understanding and handling the important risks in the organization as quickly as possible is critical as decision taking based on unknown risks or unknown changes to risks can lead to poor performance and eventually threaten the existence of the company.

Currently available methods require the users to report the risks from the lower levels to the higher levels to keep the decision takers in all superior organization levels informed. This process could be time consuming and slow as the risks needs to be reported manually. In addition, the risks usually need to be re-assessed as the risk matrices used at the higher levels in the organization typically uses more severe consequence scales.

The disclosed embodiments ensure informed decision taking methods as relevant risks created in lower levels of the organization are automatically reported to the superior organization levels. This reporting is done by normalization of the risks from the level where the risks were originally created and in all superior, i.e. higher, organizational levels. This ensures that relevant risks are reported as if they were created in the superior organizational levels. In addition, normalization of risks ensures that irrelevant risks are not reported making it easier for the organization to focus on the most critical risk issues.

As in a typical ERM systems all risks will be handled in the organizational level where they were created, that is even if they are regarded as irrelevant normalized risks in the superior organization levels. In addition, superior organization levels will have access to all risk including the normalized irrelevant risks.

The organization levels described herein are organized the ERM system in one or several layer hierarchies.

The disclosure introduces methods and system for normalization of risk assessments and aggregated presentation of risks in protection layer hierarchies.

As risk assessments often are done using different risk matrices with different risk scales, such as different levels of consequences, risk normalization is needed.

Also disclosed herein are methods for normalized presentation of risks in aggregated protection layer hierarchies where the risks are presented as if they had been assessed in other protection layers, such as in other organizational layers.

Risk assessments performed in the different levels of an organization, i.e. the different protection layers, are typically not assessed towards the same risk matrix as the consequence scales varies throughout in the organization. This means that a risk that is regarded as severe in a sub-layer can potentially be considered less severe, or even negligible, in a parent layer.

When normalizing the risk assessments, the risks levels will be adjusted, and the risks will be presented as if the risks had been assessed towards the same risk matrix. This ensures, for instance, that risks can be presented as if the risk assessments had been performed with a common risk matrix, for instance an overall ERM risk matrix.

A benefit from these normalization methods are to be able to aggregate risks into risk views with up-to-date risks pictures that are relevant for the different users of the risk management system i.e. from the executive management all the way to personnel without any management responsibility.

Various risk views are needed to be able to view the risk levels in an organization from different perspectives, i.e. risk views. For example, based on the aggregation and the layer's position in a protection layer hierarchy.

A risk view (perspective) where risks in a protection layer are normalized towards the parent layer illustrates how risks are aggregated and perceived in the organization.

Another risk view, referred to as the ERM risk view, is especially benefitable to the organization's executive management as it presents a quick view of all the risks that are considered a threat to the existence of the company. This risk view can be created by, for instance, risk normalization towards an overall ERM risk matrix.

According to a further embodiment, machine learning is used to provide a method for automatic normalization of risk assessments.

According to another embodiment, the machine learning uses algorithms to find subtle relationships in a large set of “training” data. The training process locates those relationships and encodes them into a “model,” such as a neural network. The model can then be used to find relationships between inputs like those in the training data. Once the model is sufficiently accurate on test data, it can be deployed for production use.

For an ERM system, a large set of manual risk normalizations can be used as training data. This data set is fed into a machine learning algorithm (e.g., a neural network, decision tree, support vector machine, etc.) which trains a model to “learn” a function that produces the mappings with a reasonably high accuracy.

If the machine learning algorithm is given a large enough set of inputs, i.e. risks that has been normalized, and outputs, i.e. risk normalizations, it finds the function for you. And, this function may even be able to produce the correct output for input that it has not seen during training. By this, the machine learning function will be able to normalize risks automatically.

In a case like risk normalization the model need to be transformed for the algorithm to provide useful output data, i.e. accurate risk normalizations. To ensure this transformation, the disclosed embodiments use machine learning to select the most optimal mapping area and the rating scales of the related risk matrices by analyzing the risks, risk matrices and the risk normalizations in the ERM system.

Once these mapping areas and rating scales have been established, risks can be normalized by the machine learning model automatically and accurately.

The use of mapping areas and rating scales minimizes the need for manual preparations of the data sets, as well as evaluations and tuning of the machine learning. Another benefit is that the mapping areas and rating scales can be presented in the ERM system in a graphical format understandable by an expert.

Further preferable features and advantageous details of the present invention will appear from the following example description, claims and attached drawings.

### BRIEF DESCRIPTION OF THE DRAWINGS

The invention will below be described in detail with references to the attached drawings, wherein:

FIG. 1 is a principle drawing of a typical risk management system,

FIG. 2 shows an exemplary ERM risk matrix,

FIG. 3 shows an exemplary 3×3 risk matrix,

FIG. 4 shows an exemplary 4×4 risk matrix,

FIG. 5 shows an exemplary 6×5 risk matrix,

FIG. 6 shows an exemplary extended ERM risk matrix where risk normalizations onto the extension row (C0P1 to C0P5) are neglected (ignored),

FIG. 7 shows an exemplary extended ERM risk matrix where risk normalizations onto the extension row (C0P1 to C0P5) are valuable (considered),

FIG. 8 shows an exemplary mapping of a 3×3 risk matrix onto the extended ERM risk matrix,

FIG. 9 shows an exemplary mapping of a 3×3 risk matrix onto the extended ERM risk matrix and normalization of some exemplary risk assessments,

FIG. 10 shows another exemplary mapping of a 3×3 risk matrix onto the extended ERM risk matrix and normalization of some exemplary risk assessments,

FIG. 11 shows an exemplary mapping of a 4×4 risk matrix onto the extended ERM risk matrix and normalization of some exemplary risk assessments,

FIG. 12 shows exemplary protection layers organized as an organizational hierarchy,

FIG. 13 shows exemplary mapping of risk matrices used by the organizational hierarchy in FIG. 12,

FIG. 14 shows an alternative risk view (i.e. the ERM risk view), and

FIG. 15 shows an alternative visualization of the risk view in the FIG. 14.

### DETAILED DESCRIPTION

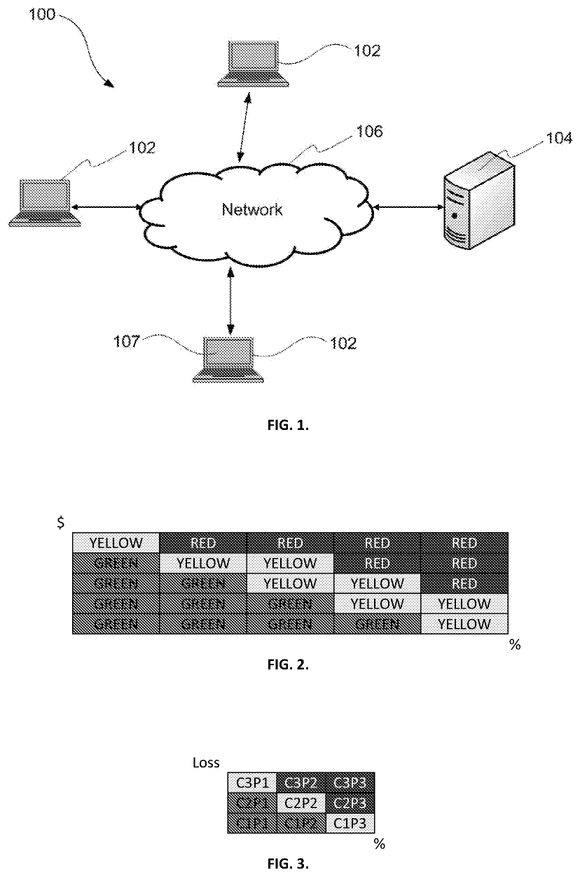

FIG. 1 illustrates an exemplary risk management system 100. A risk management system 100 may include a one or several clients 102 used by the users of the system. Clients 102 may be, for example, personal computers, network computers, tablets, smart phones, or the like, in which aspects of the illustrative embodiments may be implemented. The risk management system 100 contains at least one network 106, which is the medium used to provide communication links between various clients 102 connected together within risk management system 100. The network 106 may include connections, such as wire, wireless communication links, or fiber optic cables. The risk management system 100 may include additional servers 104, clients 102, and other devices not shown, such as one or several internal or external databases. The client(s) 102 will be provided with a graphical user interface 107, communication device adapted to the network 106, and at least one processor for processing information. The processor(s) will further be provided with means and/or software for performing the features/steps as will be discussed in FIG. 2-15. The at least one processor will further be provided with means and/or software for storing of selected mapping area (as will be described below) and storing of risk assessment normalization (as will be discussed below).

The risk matrices used in the examples are for illustration purposes only. In an implementation of the system the risk matrices can be configured with different layouts (dimensions), colors, and so on, by the users of the system with the appropriate access levels.

In the examples three (3) colors has been selected (GREEN, YELLOW, RED).

FIG. 2 shows the different levels of gray color used as substitute designations for GREEN, YELLOW and RED colors on these black and white drawings/figures.

FIG. 2 shows an exemplary ERM risk matrix that will be used in the examples for risk normalization towards an overall ERM risk matrix. This risk matrix is typically used for risk assessment with the most serve consequences, i.e, the most severe threats to the organization.

The ERM risk matrix rating scales are typically cost for the consequence scale, in this example illustrated with the ‘$’ symbol, but other consequence (severity) scales can be used. The likelihood (probability) scale is illustrated with the symbol. The likelihood (probability) scale is typically scaled between 0-100%, i.e. 0-1.

FIG. 3 shows an exemplary 3×3 risk matrix with ‘Loss’ as the consequence scale illustrating loss of some kind, i.e. potential of losing something of value. The likelihood/probability scale is illustrated with the ‘%’ symbol. In this example the cell C1P1 represents LOW loss potential with a low likelihood, the cell C2P2 represents MEDIUM loss potential with a medium likelihood, and the cell C3P3 represents HIGH loss potential with a high likelihood.

In these examples it is assumed that the likelihood scales in at least one of the risk matrices being mapped are text based, i.e, for instance LOW/MEDIUM/HIGH and some on, and not numeric, i.e. for instance 0-1 or 0-100%.

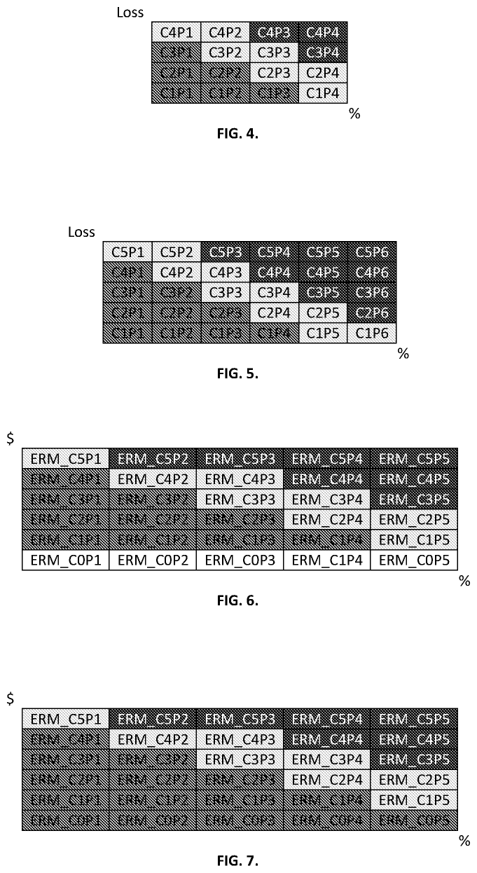

FIG. 4-5 shows other exemplary risk matrices that have been defined in the ERM system.

The administrator(s) of the system typically configures the system, like the extended risk matrices, mapping areas, scaling of risk rating scales, and so on.

FIG. 6 shows an exemplary extended ERM risk matrix. The extended ERM risk matrix is used to normalize risk assessments towards the ERM risk matrix.

The extended ERM risk matrix contains all the cells from the ERM risk matrix (FIG, 2), in addition to at least one row for mapping and scaling of consequences in other risk matrices that are too low to be categorized according to the original ERM risk matrix consequence scale,

The original cells from the ERM risk matrix has been labeled ERM_C1P1 to ERM_C5P5 (25 cells in total, 5 rows), and the cells in the additional row has been labeled ERM_C0P1 to ERM_C0P5 (5 cells in total, 1 row).

In this example, the additional row has not been assigned any color (i.e. GREEN, YELLOW or RED) as this row is outside of the original ERM risk matrix consequence scale and represents risk normalizations that are considered negligible in the ERM risk view.

This means that risk normalizations onto the extension row (C0P1 to C0P5) will be ignored (invisible) in the ERM risk view, as these risks are considered irrelevant because of their neglectable consequences compared to the ERM consequence scale.

FIG. 7 shows another exemplary extended ERM risk matrix.

This extended ERM risk matrix contains all the cells from the ERM risk matrix (FIG. 2), in addition to one row containing cells that have been assigned a color (GREEN) for mapping and scaling of consequences that will be included (valuable) also in the ERM risk view.

The original cells from the ERM risk matrix has been labeled ERM_C1P1 to ERM_C5P5 (25 cells in total, 5 rows), and the cells in the additional row has been labeled ERM_C0P1 to ERM_C0P5 (5 cells in total, 1 row).

In this example, all the cells the additional row has been assigned a GREEN color and therefor represents normalizations that will be included (valuable) in the ERM risk view, i.e. when viewing ERM risks, as GREEN rated normalized risks.

This means that all risk normalizations to the extension row (C0P1 to C0P5) will be shown in the ERM risk view.

In the following examples the system has been configured with the ERM risk matrix shown in FIG. 1 and extended as shown in FIG. 6.

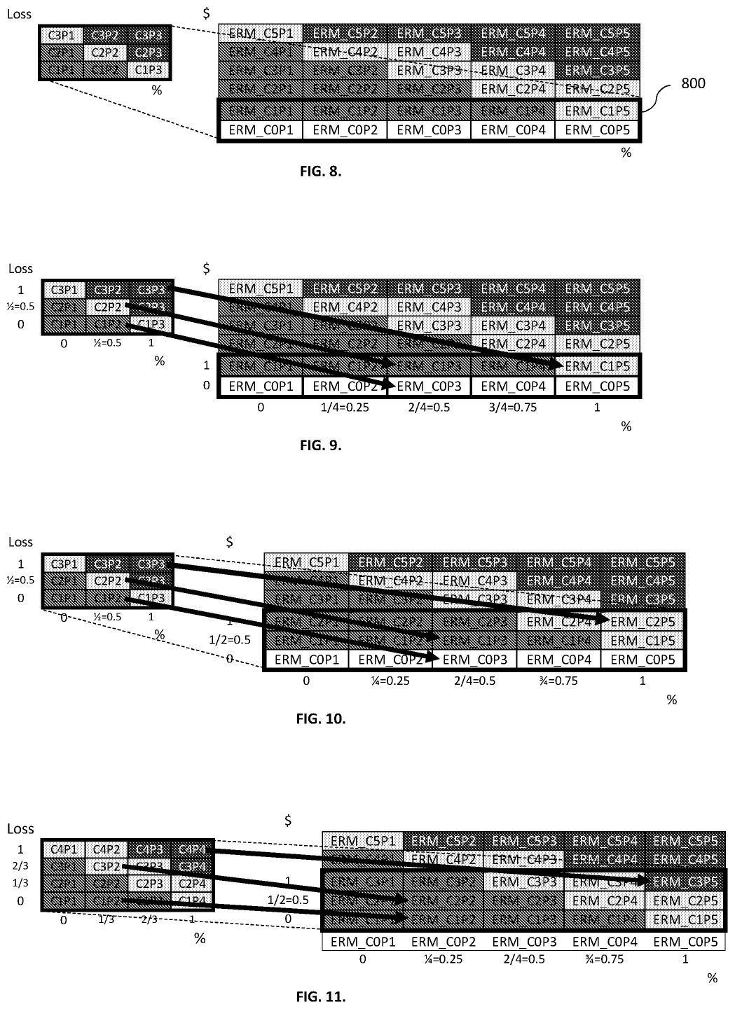

FIG. 8 shows an exemplary mapping of the 3×3 risk matrix in FIG. 3 onto the extended ERM risk matrix in FIG. 6 configured by a user of the system by selecting the corresponding mapping area in the extended ERM risk matrix and thereby establishing a relationship that will be used by the computer-implemented system for normalization and aggregation of risks.

The selected mapping area 800 for the 3×3 matrix onto the extended ERM risk matrix is indicated by a tick borderline, i.e. the cells ERM_C0P1 to ERM_C1P5 (10 cells, 2 rows). This relationship between the risk matrices is established to ensure that any risks assessed towards this 3×3 risk matrix will be normalized towards the selected mapping area 800 of the extended ERM risk matrix.

FIG. 9 shows exemplary normalization of risk rating scales and some risk normalizations towards the same mapping area as used in FIG. 8.

In the following sections FIG. 9 is explained by some examples.

First, the 3×3 matrix and the ERM mapping area rating scales need to be normalized to the same range, for instance 0 to 1 (0-100%), where each row/column in each rating scale is given a value within the normalized range.

Linear normalization of all rating scales is used in the examples, but the rating scales could be normalized differently if required for optimal mapping of the different risk scales, for instance as mix of linear, exponential, logarithmic or customized normalization of the different rating scales.

An exemplary normalization of the rating scales of the 3×3 matrix is illustrated below.

In this example, the number of rows/columns in each rating scale is counted and each rating scale index, representing the row/column id, is normalized to the same range according to a formula, for example:
Normalized scale index=(Scale index-1)/(No. of indexes in the scale −1)

As the loss (consequence) scale on the 3×3 risk matrix has 3 rows the normalization of the loss (consequence) scale will be:
Normalized consequence index 3 (row): −1
Normalized consequence index 2 (row 2): (2−1)/(3−1)=½=0.5
Normalized consequence index 1 (row 1): (1−1)/(3−1)=0

The normalization of the loss (consequence) scale of the 3×3 risk matrix is shown in FIG. 9.

As the likelihood CA scale on the 3×3 risk matrix has 3 columns the normalization of the likelihood (%) scale will be:
Normalized likelihood index 3 (column 3): (3−1)/(3−1)
Normalized likelihood index 2 (column 2): (2−1)/(3−1)=½=0.5
Normalized likelihood index 1 (column 1): (1−1)/(3−1)=0

The normalization of the likelihood (%) scale of the 3×3 risk matrix is shown in FIG. 9.

By this the 3×3 risk matrix cell C1P1 cell position can be indicated as (1,1) representing (normalized consequence index 1, normalized likelihood index 1).

In this example it is assumed that the likelihood scales in at least one of the risk matrices being mapped are text based, i.e, for instance LOW/MEDIU M/HIGH and some on, and not numeric, i.e. for instance 0-1 or 0-100%.

If the likelihood scales in both matrices being mapped where numeric, for instance 0-100%, the computer-implemented algorithm would simply use these numeric values instead of the calculated ones. As an example, a likelihood of 50% would be regarded as the value 0.5, and so on.

Exemplary normalizations of the rating scales of the ERM mapping area are illustrated below.

As the consequence ($) scale on the ERM mapping area has 2 rows the normalization of the consequence ($) scale will be:
Normalized consequence index 2 (row 2): (2−1)/(2−1)
Normalized consequence index 1 (row 1): (1−1)/(2−1)=0

The normalization of the consequence ($) scale of the ERM mapping area is shown in FIG. 9.

As the likelihood (%) scale on the ERM mapping area has 5 columns the normalization of the likelihood (%) scale will be:
Normalized likelihood index 5 (column 5): (5−1)/(5−1)=
Normalized likelihood index 4 (column 4): (4−1)/(5−1)=¾=0.75
Normalized likelihood index 3 (column 3): (3−1)/(5−1)=0.5
Normalized likelihood index 2 (column 2): (2−1)/(5−1)=¼=0.25
Normalized likelihood index 1 (column 1): (1−1)/(5−1)=0

The normalization of the likelihood scale of the ERM mapping area is shown in FIG. 9.

By this the ERM mapping area cell ERM_C0P1 cell position can be indicated as (1,1) representing (consequence index 1, likelihood index 1).

In this example it is assumed that the likelihood scales in at least one of the risk matrices being mapped are text based, i.e. for instance LOW/MEDIUM/FIIGFI and some on, and not numeric, i.e. for instance 0-1 or 0-100%.

If the likelihood scales in both matrices being mapped where numeric, for instance 0-100%, the computer-implemented algorithm would simply use these numeric values instead of the calculated ones. As an example, a likelihood of 50% would be regarded as the value 0.5, and so on.

Examples of normalization towards the ERM risk matrix for risk assessments done with the 3×3 matrix are shown below.

Normalization of a risk assessed towards the cell C3P3 in the 3×3 matrix is done according to the mapping rules:
In step 1, the normalized scale values for the cell C3P3 are identified:
C3P3 cell position (3,3) has normalized consequence (loss)=1 and normalized likelihood (%)=1.
In step 2, the normalized scale values for the cell C3P3 are matched with the cell in the extended ERM risk matrix that are closest to the normalized scale values found in step 1
The extended ERM risk matrix consequence column with a normalized value closest to 1 is the CI column at this column has a normalized value of 1.
The extended ERM risk matrix likelihood column with a normalized value closest to the value 1 is the P5 column at this column has a normalized value of 1.

As a result of the mapping in step 2, the risk assessed to the C3P3 cell in the 3×3 matrix is normalized towards the extended ERM risk matrix cell ERM_C1P5.

The example above indicates that the risk assessed towards the 3×3 risk matrix cell C3P3 is less severe from an ERM perspective as the RED risk rating (C3P3) is reduced to a normalized YELLOW rating (ERM_C1P5).

Normalization of a risk assessed towards the cell C2P2 in the 3×3 matrix is done according to the mapping rules:
In step 1, the normalized scale values for the cell C2P2 are identified:
C2P2 cell position (2,2) has normalized consequence (loss)=0.5 and normalized likelihood (%)=0.5.
In step 2, the normalized scale values for the cell C2P2 are matched with the cell in the extended ERM risk matrix that are closest to the normalized scale values found in step 1:
The extended ERM risk matrix consequence column with a normalized value closest to 0.5 is the CI column at this column has a normalized value of 1 (rule of whole numbers: 0.5 is rounded to 1).
The extended ERM risk matrix likelihood column with a normalized value closest to the value 0.5 is the P3 column at this column has a normalized value of 0.5.
As a result of the mapping in step 2, the risk assessed to the C2P2 cell in the 3×3 matrix is normalized towards the extended ERM risk matrix cell ERM_C1P3.

The example above indicates that the risk assessed towards the 3×3 risk matrix cell C2P2 is less severe from an ERM perspective as the YELLOW risk rating (C2P2) is reduced to a normalized GREEN rating (ERM_C1P3).

Normalization of a risk assessed towards the cell C1P2 in the matrix is done according to the mapping rules:
In step 1, the normalized scale values for the cell C1P2 are identified:
C1P2 cell position (1,2) has normalized consequence (loss)=0 and normalized likelihood (%)=0.5.
In step 2, the normalized scale values for the cell C1P2 are matched with the cell in the extended ERM risk matrix that are closest to the normalized scale values found in step 1:
The extended ERM risk matrix consequence column with a normalized value closest to 0 is the CO column at this column has a normalized value of 0.
The extended ERM risk matrix likelihood column with a normalized value closest to the value 0.5 is the P3 column at this column has a normalized value of 0.5.

As a result of the mapping in step 2, the risk assessed to the C1P2 cell in the 3×3 matrix is normalized towards the extended ERM risk matrix cell ERM_C0P3.

The example above indicates that the risk assessed towards the 3×3 risk matrix cell C1P2 is negligible from an ERM perspective as the GREEN risk rating C1P2 is reduced to a normalized BLANK risk rating (ERM_C0P3). This means that this risk will be ignored (invisible) when viewing the risks in the ERM risk view.

The normalization in FIG. 9 towards the extended ERM risk matrix can be summarized as follows:
The RED risk assessed with the 3×3 risk matrix will be visible in the ERM perspective, but as a likely YELLOW rated normalized risk with low-to-medium potential consequences.
The YELLOW risk assessed with the 3×3 risk matrix will be visible in the ERM perspective, but as a GREEN rated normalized risk with low potential consequences.
The GREEN risk assessed with the 3×3 risk matrix will be invisible in the ERM perspective.

FIG. 10 shows an exemplary mapping of another 3×3 risk matrix onto the extended ERM risk matrix as well as some risk normalizations.

In the following sections FIG. 10 is explained by some examples.

In this example, the normalization of the rating scales follows the same rules as used in the FIG. 9 examples. But, as the 3×3 matrix in FIG. 10 has a more severe consequence scale seen from the ERM perspective compared to FIG. 9 the normalization of the ERM mapping area consequence scale will be different.

So, the normalization of the consequence ($) scale of the ERM mapping area needs to be performed. In this example, the same formula s in FIG. 9 is used:
Normalized scale index=(Scale index −1)/(No. of indexes in the scale −1)

As the consequence ($) scale on the ERM mapping area has 3 rows the normalization of the consequence ($) scale will be:
Normalized consequence index 3 (row 3): (3−1)/(3−1)
Normalized consequence index 2 (row 2): (2−1)/(3−1)=½=0.5
Normalized consequence index 1 (row 1): (1−1)/(3−1)=0

The normalization of the consequence ($) scale of the ERM mapping area is shown in FIG. 10.

By this the ERM mapping area cell ERM_C0P1 cell position can be indicated as (1,1) representing (normalized consequence index 1, normalized likelihood index 1).

Examples of normalization towards the ERM risk matrix for risk assessments done with the 3×3 matrix are shown below.

Normalization of a risk assessed towards the cell C3P3 in the 3×3 matrix is done according to the mapping rules:
In step 1, the normalized scale values for the cell C3P3 are identified:
C3P3 cell position (3,3) normalized consequence (loss)=1 and has normalized likelihood (%)=1.
In step 2, the normalized scale values for the cell C3P3 are matched with the cell in the extended ERM risk matrix that are closest to the normalized scale values found in step 1:
The extended ERM risk matrix consequence column with a normalized value closest to 1 is the C2 column at this column has a normalized value of 1.
The extended ERM risk matrix likelihood column with a normalized value closest to the value 1 is the P5 column at this column has a normalized value of 1.

As a result of the mapping in step 2, the risk assessed to the C3P3 cell in the 3×3 matrix is normalized towards the extended ERM risk matrix cell ERM C2P5.

The example above indicates that the risk assessed towards the 3×3 risk matrix cell C3P3 is less severe from an ERM perspective as the RED risk rating (C3P3) is reduced to a normalized YELLOW risk rating (ERM_C2P5).

Normalization of a risk assessed towards the cell C2P2 in the 3×3 matrix is done according to the mapping rules:
In step 1, the normalized scale values for the cell C2P2 are identified:
C2P2 cell position (2,2) has normalized consequence (loss)=0.5and normalized likelihood (%)=0.5.
In step 2, the normalized scale values for the cell C2P2 are matched with the cell in the extended ERM risk matrix that are closest to the normalized scale values found in step 1:
The extended ERM risk matrix consequence column with a normalized value closest to 0.5 is the CI column at this column has a normalized value of 0.5.
The extended ERM risk matrix likelihood column with a normalized value closest to the value 0.5 is the P3 column at this column has a normalized value of 0.5.

As a result of the mapping in step 2, the risk assessed to the C2P2 ell in the 3×3 matrix is normalized towards the extended ERM risk matrix cell ERM C1P3.

The example above indicates that the risk assessed towards the 3×3 risk matrix cell C2P2 is less severe from an ERM perspective as the YELLOW risk rating (C2P2) is reduced to a normalized GREEN rating (ERM_C1P3).

Normalization of a risk assessed towards the cell C1P2 in the 3×3 matrix is done according to the mapping rules:
In step 1, the normalized scale values for the cell C1P2 are identified:
C1P2 cell position (1,2) has normalized consequence (loss)=0 and normalized likelihood (%)=0.5.
In step 2, the normalized scale values for the cell C1P2 are matched with the cell in the extended ERM risk matrix that are closest to the normalized scale values found in step 1:
The extended ERM risk matrix consequence column with a normalized value closest to 0 is the CO column at this column has a normalized value of 0.
The extended ERM risk matrix likelihood column with a normalized value closest to the value 0.5 is the P3 column at this column has a normalized value of 0.5.

As a result of the mapping in step 2, the risk assessed to the C1P2 cell in the 3×3 matrix is normalized towards the extended ERM risk matrix cell ERM_C0P3.

The example above indicates that the risk assessed towards the 3×3 risk matrix cell C1P2 is negligible from an ERM perspective as the GREEN risk rating C1P2 is reduced to a normalized BLANK risk rating (ERM_C0P3). This means that this risk will be ignored (invisible) when viewing the risks in the ERM risk view.

The normalization in FIG. 10 towards the extended ERM risk matrix can be summarized as follows:
The RED risk assessed with the 3×3 risk matrix will be visible in the ERM perspective, but as a likely YELLOW rated normalized risk with low potential consequences.
The YELLOW risk assessed with the 3×3 risk matrix will be visible in the ERM perspective, but as a GREEN rated normalized risk with low potential consequences.
The GREEN risk assessed with the 3×3 risk matrix will be invisible in the ERM perspective.

FIG. 11 shows another exemplary mapping of a 4×4 risk matrix onto the extended ERM risk matrix as well as some risk normalizations.

In the following sections FIG. 11 is explained by some examples.

In this example, linear normalization of the 4×4 rating scales and ERM mapping area scales has been performed according to the same methods described in the previous examples.

The normalization of the rating scales of the 4×4 risk matrix and the ERM mapping area are shown in FIG. 11.

By this the ERM mapping area cell ERM_C1P1 cell position can be indicated as (1,1) representing (likelihood index 1, consequence index 1).

Examples of normalization towards the ERM risk matrix for risk assessments done with the 4×4 matrix are shown below.

Normalization of a risk assessed towards the cell C4P4 in the 4×4 matrix is done according to the mapping rules:
In step 1, the normalized scale values for the cell C4P4 are identified:
C4P4 cell position (4,4) has normalized consequence (loss)=1 and normalized likelihood (%)=1.
In step 2, the normalized scale values for the cell C4P4 are matched with the cell in the extended ERM risk matrix that are closest to the normalized scale values found in step 1:
The extended ERM risk matrix consequence column with a normalized value closest to 1 is the C3 column at this column has a normalized value of 1.
The extended ERM risk matrix likelihood column with a normalized value closest to the value 1 is the P5 column at this column has a normalized value of 1.
As a result of the mapping in step 2, the risk assessed to the C4P4 cell in the 4×4 matrix is normalized towards the extended ERM risk matrix cell ERM C3P5.

The example above indicates that the risk assessed towards the 4×4 risk matrix cell C4P4 is severe also from an ERM perspective as the RED risk rating (C4P4) is maintained as a normalized RED risk rating (ERM_C3P5).

Normalization of a risk assessed towards the cell C3P2 in the 4×4 matrix is done according to the mapping rules:
In step 1, the normalized scale values for the cell C3P2 are identified:
C3P2 cell position (3,2) has normalized consequence (loss)=0.67 and normalized likelihood (%)=0.33
In step 2, the normalized scale values for the cell C3P2 are matched with the cell in the extended ERM risk matrix that are closest to the normalized scale values found in step 1:
The extended ERM risk matrix consequence column with a normalized value closest to 0.67 is the C2 column at this column has a normalized value of 0.5.
The extended ERM risk matrix likelihood column with a normalized value closest to the value 0.33 is the P2 column at this column has a normalized value of 0.25.
As a result of the mapping in step 2, the risk assessed to the C3P2 cell in the 4×4 matrix is normalized towards the extended ERM risk matrix cell ERM_C2P2.

The example above indicates that the risk assessed towards the 4×4 risk matrix cell C3P2 is less severe from an ERM perspective as the YELLOW risk rating (C3P2) is reduced to a normalized GREEN rating (ERM_C2P2).

Normalization of a risk assessed towards the cell C1P2 in the 4×4 matrix is done according to the mapping rules:
In step 1, the normalized scale values for the cell C1P2 are identified:
C1P2 cell position (1,2) has normalized consequence (loss)=0 and normalized likelihood (%)=0.33.
In step 2, the normalized scale values for the cell C1P2 are matched with the cell in the extended ERM risk matrix that are closest to the normalized scale values found in step 1:
The extended ERM risk matrix consequence column with a normalized value closest to 0 is the C1 column at this column has a normalized value of 0.
The extended ERM risk matrix likelihood column with a normalized value closest to the value 0.33 is the P2 column at this column has a normalized value of 0.25.
As a result of the mapping in step 2, the risk assessed to the C1P2 cell in the 4×4 matrix is normalized towards the extended ERM risk matrix cell ERM_C1P2.

The example above indicates that the risk assessed towards the 4×4 risk matrix cell C1P2 is severe also from an ERM perspective as the GREEN risk rating (C3P2) is normalized to a GREEN rating (ERM_C2P2).

The normalization in FIG. 11 towards the ERM risk matrix can be summarized as follows:
The RED risk assessed with the 4×4 risk matrix will be visible in the ERM perspective as a RED rated normalized risk with medium potential consequences.
The YELLOW risk assessed with the 4×4 risk matrix will be visible in the ERM perspective, but as a GREEN rated normalized risk with low-to-medium potential consequences.
The GREEN risk assessed with the 4×4 risk matrix will be visible in the ERM perspective as a GREEN rated normalized risk with low potential consequences.

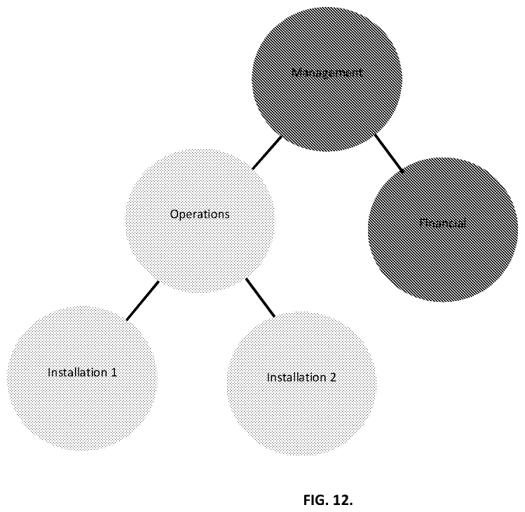

FIG. 12 shows an exemplary organizational hierarchy.

Each organizational layer in the hierarchy, i.e. protection layer, has its own risks that have been assessed towards a selection of risk matrices used by the specific layer.

In this example, the organizational layer symbols show the color of the most severe risk(s), i.e. risks with the most severe risk assessment(s), normalized to or assessed (created) in the specific organizational layer.

The connections, i.e, the black lines, in the hierarchy illustrates the relationship between the different organizational layers. A sub-layer is a layer that is connected directly below another layer, i.e, the parent layer, as illustrated with a black connection line.

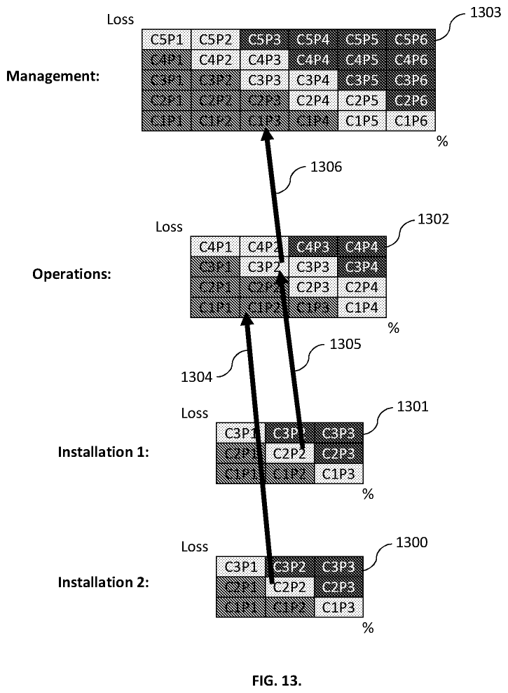

FIG. 13 shows exemplary mapping of risk matrices used by the organizational hierarchy in FIG. 12.

In this example an exemplary method for normalization is described where the risk assessments in a sub-layer are normalized towards a risk matrix in the parent layer.

In this example the following risk matrices has been used by the layers:
Risk matrix number 1303 is used by the organizational layer labeled ‘Management’.
Risk matrix 1302 is used by the organizational layers labeled ‘Operations’ and ‘Financial’
Risk matrix 1301 is used by the organizational layer labeled ‘Installation’.

Risk matrix 1300 is used by the organizational layer labeled and ‘Installation 2’.

In this example, risk matrix 1300 and 1301 is the same risk matrix. But as the layer labeled ‘Installation is of more importance to the parent layer labeled ‘Operations’, its risk matrix 1301 has been mapped towards risk matrix number 1302 with more severe consequences compared to the mapping of risk matrix 1300 used by the organizational layer labeled and ‘Installation 2’.

The YELLOW colored layer symbols in FIG. 12 indicate that the organizational layers labeled ‘Installation and ‘Installation 2’ contains at least one YELLOW rated risk as these layers do not have any sub-layers.

In this example, the organizational layers labeled ‘Installation and ‘Installation both contains a YELLOW rated risk assessed to risk matrix cell C2P2. No other risks exist in these two layers.

The organizational layer labeled ‘Operations’ does not have any own risks. As this organizational layer has a direct parent-child relationship (indicated with the black connection lines) towards the two (2) sub-layers labeled ‘Installation and ‘Installation 2’, risks in these organizational sub layers will be normalized towards this parent layer if their risk matrices 1300 or 1301 has been mapped towards risk matrices in this layer. In this example both risk matrices 1300 or 1301 has been mapped towards risk matrix 1302 used by the organizational layer labeled ‘Operations’.

As risk matrix number 1300 and 1301 has been mapped towards risk matrix number 1302, both YELLOW rated risks in the organizational layers labeled ‘Installation and ‘Installation 2’ will be normalized towards the organizational layer labeled ‘Operations’, as illustrated by risk normalization 1304 and 1305.

As the organizational layer labeled ‘Operations’ do not have any own risks, its YELLOW color indicates that one or several risk in the organizational sub-layers labeled ‘Installation and ‘Installation 2’ has been normalized towards the organizational layer labeled ‘Operations’ as YELLOW rated risks.

In this example, the YELLOW rated risk in the organizational layer labeled ‘Operations’ is the normalized risk 1305 from the organizational layer labeled ‘Installation that has been normalized towards risk matrix 1302 cell C3P2.

The organizational layer labeled ‘Management’ do not have its own risks. As this organizational layer has a direct parent-child relationship (indicated with the black connection line) towards the organizational sub-layer labeled ‘Operations’, risks in this organizational layer will be normalized towards the organizational layer labeled ‘Management’ if any of their risk matrices has been mapped towards the risk matrix 1303 in this layer.

As the organizational layer labeled ‘Management’ does not have any own risks, its GREEN colored layer symbol indicates that one or several risk in the organizational sub-layer labeled ‘Operations’ has been normalized towards this organizational layer as GREEN rated risks.

In this example, the GREEN rated risk in the organizational layer labeled ‘Management’ is the normalized risk from the organizational layer labeled ‘Operations’ that has been normalized 1306 towards risk matrix 1303 cell C1P3.

The organizational layer labeled ‘Management’ also has a relationship (indicated by the black connection line) towards the organizational sub-layer labeled ‘Financial’. This relationship follows the same rules for normalization and aggregation as explained in the previous examples.

The normalization of the risks illustrated in FIG. 12-13 can be summarized as:
The risk normalizations are performed from a sub-layer to its parent.
The risk nor lizations to a layer are normalized again if this layer also has a parent.
The YELLOW rated risk in the organizational layer labeled ‘Installation has been normalized 1305 towards the layer labeled ‘Operations’ as a YELLOW rated risk and will therefore be visible in the organizational layer labeled ‘Operations’ as a YELLOW normalized risk.
The YELLOW rated risk in the organizational layer labeled ‘Installation 2’ has been normalized 1304 towards the layer labeled ‘Operations’ as a GREEN rated risk and will therefore be visible in the organizational layer labeled ‘Operations’ as a GREEN normalized risk.
The normalized risks in the organizational layer labeled ‘Operations’ has been normalized again, this time towards the layer labeled ‘Management’:
The normalization of the risk that was normalized to cell C3P2 in risk matrix 1302 has been normalized 1306 towards the cell C1P3 in risk matrix 1303, i.e, as a normalized GREEN rated risk and will therefore be valid (visible) in the organizational layer labeled ‘Management’ as a GREEN normalized risk
The normalization of the risk that was normalized to cell C1P2 in risk matrix 1302 has been normalized towards a cell in the uncolored extension row of risk matrix 1303 will therefore be ignored (invisible) in the organizational layer labeled ‘Management’.

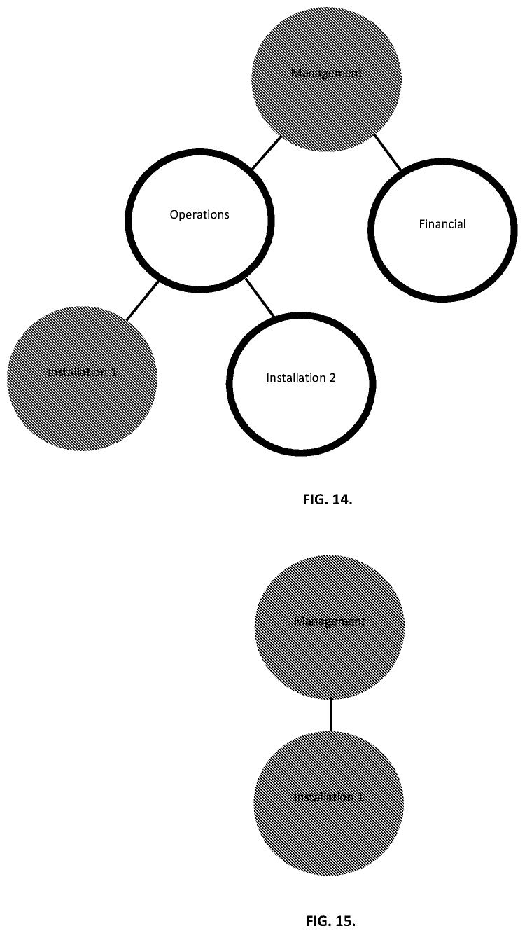

FIG. 14 illustrates an alternative risk view where the normalized risks are only presented in the organizational layer where the risk was originally assessed. In addition, the risks are presented as if they were normalized towards an overall risk matrix that do not necessarily have to be used in the parent layer.

In this example, the risks appear as if normalized towards an overall ERM risk matrix, i.e. the ERM risk view.

The risks are the same as used in the FIG. 12-13 examples, but with an additional GREEN rated risk that has been assessed towards the ERM matrix in the organizational layer labeled ‘Management’.

The organizational layer labeled ‘Installation 1’ has a risk originally rated as YELLOW and normalized as a GREEN risk towards the ERM risk matrix.

As only the organizational layers labeled ‘Management’ and the organizational layers labeled ‘Installation has a risk that are valid in the ERM risk view, the hierarchy is displayed as indicated in FIG. 14.

FIG. 15 shows an alternative visualization of the hierarchy in the FIG. 14 where only the organizational layers with ERM related risks are shown, i.e. layers with risks that have been assessed or normalized as valid risks towards the ERM risk matrix. This alternative view is especially useful for huge organizations for a compressed ERM risk view.

As illustrated in the examples, a benefit from this normalization technology is too be able to aggregate risks into risk views with up-to-date risks pictures that are relevant for the different users of the risk management system, i.e. from management to the ordinary users of the system.

It should be noted that risks and protection layers will typically only be presented to the users that have been granted with the right access privileges as illustrated in prior-art WO 2018026286 A1

A user of the ERM system configures the system, including the risk matrices and the extended risk matrices, mapping areas, scaling of risk rating scales, and so on. The configuration in then used by the ERM system server(s) 104 processor(s) to perform risk normalization according to normalization algorithms configured for the system, such as exemplified above, and to present these normalized risks in a graphical user interface 107.

The user stories below describe some of the benefits of the current invention.

Need: As a member of the senior management I want to be informed about the most important risks handled by my company right now.

User story: Senior management controls its own organizational levels where they create and maintain risks. In addition to the risks created by themselves they will also be able to see and interact with normalized risks that has been created in other parts of the organization if they are relevant to them. These normalized risks will be displayed just like the risks that the group members created as they are just as important to them as the risks that they created themselves.

For instance, the Project department creates a risk where a major financial loss is regarded as possible if no mitigation actions are executed by the end of the day. As soon as this high rated risk is created it is automatically normalized as a high rated risk in the Finance department, and a medium rated risk for the CEO and the Board.

This automated risk normalization technology uses the relationship between the risk matrices in the different parts of the organization to automatically normalize risks with precision and in real time.

Benefit: Senior management are informed about new important risks as soon as they are created and can contribute in the process of solving a threat or realizing an opportunity.

By this, the users do not have to report risks in the organization as relevant risks are reported automatically throw-out the organization as if the risk assessment had been performed locally.

This is total risk transparency, enabling the whole organization to know all relevant risks and handle them openly.

Need: As a member of the senior management I do not want to be informed about the irrelevant risks handled by my company right now.

User story: Senior management controls its own organizational levels where they create and maintain risks. In addition to the risks created by themselves they will also be able to see and interact with normalized risks that has been created in other parts of the organization if they are relevant to them. These normalized risks will be displayed just like the risks that the group members created as they are just as important to them as the risks that they created themselves.

For instance, the Project Department creates a medium rated risk. As soon as this medium rated risk is created it is automatically normalized by the system as a low rated risk in the Finance department, and as an irrelevant risk for the CEO and the Board. As irrelevant risks are not presented the CEO and the Board can easily focus on the important risks that are relevant to them.

By switching from the normalized view to the ‘all risk’ view the CEO and the Board are able to see all risks, as all risks will be presented in the organization where they were originally created.

The invention can also benefit from using machine learning to provide a method for automatic normalization of risk assessments.

In the examples below it is assumed that there are a lot of risk normalizations, i.e. a big dataset, in the ERM system that can be analyzed by machine learning. The invention uses machine learning to select the optimal mapping areas of related risk matrices by analyzing the risk normalizations in the ERM system to establish a model based on the dataset, i.e. based on training.

By the use of machine learning one will find the optimal mapping area in the extended ERM matrix as well as the corresponding scale values for both matrices. The mapping area and the scale values will be stored in the ERM system for future automatic risk normalizations as they represent the normalization relationship, i.e. a machine learning model, between these two matrices.

FIG. 9 shows an exemplary mapping of a 3×3 risk matrix onto the extended ERM risk matrix and normalization of some exemplary risk assessments.

Now assume that most risk normalizations between these two risk matrices are illustrated by the arrows for some example normalizations, In addition, assume that most of the normalizations between these two matrices fall within the mapping area illustrated by the tick borderline.

The system according to the present invention will use machine learning to analyze all risk normalizations between the 3×3 risk matrix and the extended ERM risk matrix by the use of known machine learning algorithms to predict, i.e. to establish or to propose machine learning model alternatives for, the most optimal mapping area as indicated by the tick borderline in the extended ERM risk matrix including the risk rating scales for both the 3×3 risk matrix and the extended ERM matrix as indicated by the numbers on the figure (0, 0.25, 0.5. 0.75 and 1).

First, the mapping area is identified by the machine learning algorithms by selecting the mapping area that matches most of the risk normalizations between the two risk matrices. If the algorithms detect several mapping area candidates, then each of these mapping area candidates are analyzed further as described below.

For each of the mapping area candidates, the system uses machine learning algorithms to identify the optimal scaling of the risk rating scales for both the 3×3 risk matrix and the extended ERM matrix. The risk rating scales will be scaled by the machine learning algorithms in a variety of ways; for instance, linear for all risk scales or linear for one of the risk scales and logarithmic for the other scales and so on. The machine learning algorithm will select the optimal combination of risk rating scales that would ensure that most of the risk normalizations between the two risk matrices matches the dataset, i.e. risk normalizations between these two matrices.

Then the machine learning algorithms will select the mapping area candidate and associated risk rating scales that matches most of the risk normalizations between the two risk matrices, i.e. the mapping area candidate and risk scales that would normalize most of the risks in the dataset to the normalized risks in the dataset, to establish or to propose a machine learning model.

The selected machine learning model, i.e. the selected mapping area candidate and associated risk rating scales can be used by the ERM system to normalize new risks in the system automatically. The machine learning model will contain one or several models, i.e. one for each of the risk normalization relationship detected by the machine learning algorithms.

Once the normalization relationships have been established risks can be normalized accurately by the machine learning model, for instance by normalizing a C3P2 risk in the 3×3 matrix towards the ERM matrix automatically. This could be done by using the mapping rules described in the previous examples.

In the example above the machine learning algorithm only detected one mapping area candidate, but if there exist some additional risk normalizations outside of the selected mapping area the algorithm could potentially identify other mapping area candidate(s).

For instance, the machine learning algorithm could potentially detect an additional mapping area candidate if two (2) of the risk normalizations between the 3×3 matrix and the extended ERM matrix that has been assessed towards the C3P3 cell, have been normalized towards the ERM_C2P5 cell. If so, this mapping area candidate could potentially be the one indicated by tick lines in FIG. 10.

In an alternative implementation of the system, an administrator of the ERM system will be presented for the machine learning model alternatives, for instance presented in a prioritized list in the graphical user interface where the best matching candidate is listed first. The user can then evaluate the different mapping area candidates in the ranked list, for instance indicated with a score between 0 to 100 percent, and select the one that should be used by the ERM system. The user should be able to see the normalizations matching the mapping area candidate as well as the once that are does not match, i.e. risk normalizations that falls outside of the mapping area candidate. In addition, the administrator should also see the associated risk rating scales for each of the mapping area candidates.

The machine learning algorithm will also be able to detect systematic user anomalies. For instance, if a user or a department systematically creates risks that are assessed with to high consequence or probability (likelihood) scores. Such patterns of anomalies should also be presented to the administrator of the ERM system making it easier to select the optimal mapping area candidate, but also to exclude certain risk normalizations from the machine learning algorithm and/or to correct certain risk assessments and normalizations before running the machine learning algorithms again producing new mapping area candidates and associated risk rating scales.

The machine learning algorithm should also be able to detect ethical issues as loss of life and environmental damage and other ethical issues could be part of consequence scales for all or a subset of the risk matrices in the ERM system.

Detected ethical issues should be presented to the administrator of he ERM system and the administrator and/or the users of the system can then make the necessary adjustment to these risks and other systematic anomalies detected by the machine learning algorithm.

The list of candidates and its anomalies is desirable as it provides an interactive visualization, which can better combine the human ability to detect anomalies and the power of machines to process large amounts of data.

After the risks has been adjusted, the machine learning algorithms could be run again updating the area mapping candidates and the associated the risk rating scales of the matrices for each of the normalization relationships (i.e. model candidates), as well as identifying new systematic user anomalies as well as ethical issue candidates, and present these to the user of the ERM system, such as an administrator of the ERM system.

In a hierarchal organization, a risk normalization could potentially be performed between a layer that is potentially several levels higher up in the organization, for instance as illustrated in FIG. 13, where for instance someone in the Management layer normalized a risk in the layer Installation 2 directly. In this example, it is assumed that the risk assessment C2P2 in the layer Installation 2 has been normalized directly towards the Management layer with the risk assessment C1P3, i.e. without being normalized in the layer Operations.

The machine learning models will use the structure of the organization as illustrated in FIG. 12 to detect that there exists a layer named Operations between the Management layer and the Installation 2 layer. This relationship, and the dataset of normalizations in the ERM system will be used to detect, modify or to propose mapping relationships between risk matrices in the layer Installation 2 and the layer Operations, as well as between the layer Operations and the layer Management, i.e. one for each of the organizational layer relationships, as illustrated in FIG. 13 with arrows.

### Modifications

In an alternative implementation the extended risk matrix used for normalizing of risks can be extended with additional rows for a wider range of consequences.

The cells in additional row(s) can be colored according to their risk level. This means that one or several of the additional rows or cells can have risk rating colors.

If a risk has been assessed towards more than one risk matrix all its risk assessments will be normalized. In an alternative implementation the most severe of the normalized risk ratings will be used in the risk view(s) to avoid duplicates.

In an alternative implementation where the consequence scales of the risk matrices are scaled towards a common consequence scale, for instance a monetary value, automatic mapping of the risk matrices would be possible.

In an alternative implantation where the probability scale is not standardized as in the examples the extended ERM matrix can be extended with one or more additional probability columns.

In addition, the selected mapping area for normalizing of risks can be configured to only partly cover the likelihood (probability) scale.

1-15. (canceled)

16. A data processing Enterprise Risk Management method, comprising the steps of:
(a) providing an initial Enterprise Risk Management System risk matrix (ERM risk matrix) having a plurality of cells as basis;
(b) using at least one processor to form an extended ERM risk matrix from the initial ERM risk matrix by adding at least one row of cells to the initial ERM risk matrix for mapping and scaling of at least one other risk matrix,
(c) mapping the at least one other risk matrix by selecting a corresponding mapping area (800) in the extended ERM risk matrix and storing the selected mapping area (800) of the of the at least one other risk matrix,
(d) using the at least one processor to perform scale normalizations of the at least one other risk matrix and the corresponding stored selected mapping area (800) in the extended ERM risk matrix to the same normalization ranges,
(e) using the at least one processor to perform risk assessment normalization of risks assessed towards the at least one other risk matrix onto the corresponding selected mapping area (800) of the extended ERM risk matrix by selecting the mapping area (800) cell with normalized scale values mathematically closest to the normalized scale values of the risk assessment of the at least one other risk matrix, and
(f) using the at least one processor to create normalized risks from the selected mapping area (800) cells in step (e).

17. The method according to claim 16, wherein the corresponding mapping area (800) is selected manually by user interaction or automatically via a machine learning model.

18. The method according to claim 16, wherein the mapping areal (800) cell with normalized scale values mathematically closest to the normalized scale values of the risk assessment of the at least one other risk matrix is selected manually by user interaction or automatically by means of a machine learning model.

19. The method according to claim 16, comprising the step of normalizing and mapping risk matrices according to organizational hierarchy before mapping and risk normalization into the extended ERM risk matrix.

20. The method according to claim 18, wherein the step of mapping and normalizing risk matrices includes mapping and normalizing at least one sub-layer risk matrix into a parent layer risk matrix.

21. The method of claim 18, wherein the step of normalizing the of the risk rating scales of the extended ERM risk matrix and at least one other risk matrix, the sub-layer risk matrix or parental layer risk matrix is performed via or a mix of linear, exponential, logarithmic or customized normalization or a combination thereof.

22. The method according to claim 16, wherein the step of normalizing the risk rating scales of the extended ERM risk matrix and at least one other risk matrix is performed by linear, exponential, logarithmic or customized normalization or a combination thereof.

23. The method according to claim 21, comprising counting the number of rows and columns in each risk rating scale and each risk rating scale index, representing the row or column id, and normalizing the at least one other risk matrix, sub-layer risk matrix, parental layer risk matrix, and the selected mapping area (800) of the extended ERM risk matrix according to the formula:
Normalized scale index=(Scale index-1)/(No. of indexes in the scale-1).

24. The method according to claim 16, comprising counting the number of rows and columns in each risk rating scale and each risk rating scale index, representing the row or column id, and normalizing the at least one other risk matrix and the selected mapping area (800) of the extended ERM risk matrix according to the formula:
Normalized scale index=(Scale index-1)/(No. of indexes in the scale-1).

25. The method according to claim 18, comprising counting the number of rows and columns in each risk rating scale and each risk rating scale index, representing the row or column id, and normalizing the at least one other risk matrix and the selected mapping area (800) of the extended ERM risk matrix according to the formula:
Normalized scale index=(Scale index-1)/(No. of indexes in the scale-1).

26. The method according to claim 16, comprising configuring the selected mapping for normalization and mapping of risks to only partly cover scaling of consequences.

27. A risk management system (100) comprising:
at least one client (102),
a network (106) providing communication links between various clients (102) connected together within the risk management system (100), the client (102) being provided with a communication device adapted to the network (106), a graphical user interface (107) and at least one processor for processing information, wherein
the at least one processor includes software for:
(a) based on an initial Enterprise Risk Management risk matrix (ERM risk matrix) having a plurality of cells, forming an extended ERM risk matrix by adding at least one row to the initial ERM risk matrix for mapping and scaling of consequences of at least one other risk matrix,
(b) mapping the at least one other risk matrix by selecting a corresponding mapping area (800) of cells in the extended ERM risk matrix, and storing the selected mapping area (800) of the at least one other risk matrix,
(c) performing scale normalizations of the at least one other risk matrix and the stored corresponding selected mapping area (800) in the extended ERM risk matrix to the same normalization ranges,
(d) performing risk assessment normalization of risks assessed towards the at least one other risk matrix onto the corresponding selected mapping area (800) of the extended ERM risk matrix by selecting the mapping area (800) cell with normalized scale values mathematically closest to the normalized scale values of the risk assessment of the at least one other risk matrix, and
(e) creating normalized risks from the selected mapping area (800) cells.

28. The system according to claim 27, wherein the at least one processor is further provided with software for performing risk normalization and mapping of risk matrices according to organizational hierarchy prior to mapping and risk normalization into the extended ERM risk matrix.

29. The system according to claim 28, wherein the at least one processor is further provided with software for performing risk normalization and mapping at least one sub-layer risk matrix into a parent layer risk matrix.

30. The system according to claim 27, wherein the at least one processor is further provided with software for performing linear, exponential, logarithmic or customized normalization or a combination thereof of the risk rating scales of the extended ERM risk matrix and at least one other risk matrix.

31. The system according to claim 29, wherein the at least one processor is further provided with software for performing linear, exponential, logarithmic or customized normalization or a combination thereof of the risk rating scales of the extended ERM risk matrix and at least one other risk matrix, sub-layer risk matrix, or parental layer risk matrix.

32. The system according to claim 30, wherein the at least one processor is further provided with software for counting the number of rows and columns in each risk rating scale and each risk rating scale index, representing the row and column id, and normalizing the at least one other risk matrix and the selected mapping area (800) of the extended ERM risk matrix according to the formula:
Normalized scale index=(Scale index-1)/(No. of indexes in the scale-1).

33. The system according to claim 31, wherein the at least one processor is further provided with software for counting the number of rows and columns in each risk rating scale and each risk rating scale index, representing the row and column id, and normalizing the at least one other risk matrix, sub-layer risk matrix, parental layer risk matrix, and the selected mapping area (800) of the extended ERM risk matrix according to the formula:
Normalized scale index=(Scale index-1)/(No. of indexes in the scale-1).

34. The system according to claim 27, wherein the at least one processor is further provided with software for configuring the selected mapping for normalization and mapping of risks to only partly cover scaling of consequences.

35. The system according to claim 27, wherein
the corresponding mapping area (800) is selected based on user input or the at least one processor is provided with software for machine learning for the selection, or
the mapping area (800) cell with normalized scale values mathematically closest to the normalized scale values of the risk assessment of the at least one other risk matrix is selected based on user input or the at least one processor is provided with software for machine learning for the selection, or
the corresponding mapping area (800) and the mapping area (800) cell with normalized scale values mathematically closest to the normalized scale values of the risk assessment of the at least one other risk matrix is selected based on user input or the at least one processor is provided with software for machine learning for the selection.
